(19) United States
(12) Patent Application Publication
(10) Pub. No.: US 2026/0097674 A1
(43) Pub. Date: Apr. 9, 2026

(54) VEHICLE CONTROL DEVICE

(71) Applicant: NISSAN NORTH AMERICA, INC., Franklin, TN (US)

(72) Inventors: Yoshinori SUZUE, Mountain View, CA (US); Aaron Isaac KANDEL, San Francisco, CA (US); Geoffrey Andrew PETTET, Oakland, CA (US)

(21) Appl. No.: 18/907,464

(22) Filed: Oct. 4, 2024

(51) Int. Cl. B60L 53/62; B60L 53/66

(52) U.S. Cl. CPC B60L 53/62; B60L 53/66

(57) ABSTRACT

An electric vehicle control device includes an electronic charging schedule generator, a non-transitory computer readable medium and an electronic controller. The electronic charging schedule generator is configured to generate a charging schedule when a vehicle accesses a charging port provided at a building structure that is powered by an electric source. The non-transitory computer readable medium electronically stores personalized vehicle history of the vehicle during vehicle travel. The electronic controller is programmed to receive the charging schedule and to compare the charging schedule with the personalized vehicle history. The electronic controller is programmed to generate an updated charging schedule based on the comparison.

### BACKGROUND

### Technical Field

The present disclosure generally relates to a vehicle control device. More specifically, the present disclosure relates to a vehicle control device for informing vehicle charging protocol.

### Background Information

Conventional charging schedules for electric vehicle charging are generated based on user input for state-of-charge or the times for a vehicle arriving or leaving a building structure. However, conventional methods require sharing private data with the building which can result in too much data sharing or loss of the vehicle owner’s privacy. Additionally, conventional charging schedule generation requires perfect information sharing from drivers to the building structure, which is subject to inaccuracies as it places a high burden on user sharing of information.

### SUMMARY

In view of the state of the known technology, one aspect of the present disclosure is to provide an electric vehicle control device includes an electronic charging schedule generator, a non-transitory computer readable medium and an electronic controller. The electronic charging schedule generator is configured to generate a charging schedule when a vehicle accesses a charging port provided at a building structure that is powered by an electric source. The non-transitory computer readable medium electronically stores personalized vehicle history of the vehicle during vehicle travel. The electronic controller is programmed to receive the charging schedule and to compare the charging schedule with the personalized vehicle history. The electronic controller is programmed to generate an updated charging schedule based on the comparison.

In view of the state of the known technology, another aspect of the present disclosure is to provide an electronic controller comprising an electronic communicator in electronic communication with a non-transitory computer readable medium electronically storing personalized vehicle history of the vehicle during vehicle travel. The electronic communication is in further communication with an electronic charging schedule generator external to a vehicle that is configured to generate a charging schedule when the vehicle accesses a charging port provided at a building structure that is powered by an electric source. The electronic controller is programmed to receive the charging schedule and to compare the charging schedule with the personalized vehicle history. The electronic controller is programmed to generate an updated charging schedule based on the comparison.

### BRIEF DESCRIPTION OF THE DRAWINGS

Referring now to the attached drawings which form a part of this original disclosure:

FIG. 1 is a schematic diagram of a vehicle control system having a vehicle home determination setting device and a vehicle control device in accordance with an illustrated embodiment;

FIG. 2 is a schematic diagram of a vehicle equipped with the vehicle control device;

FIG. 3 is a schematic diagram of the components of an electronic controller of the vehicle control device;

FIG. 4 is a flowchart of steps executed by the electronic controller of the vehicle control device;

FIG. 5 is schematic diagram illustrating information exchange between the components of the vehicle control device;

FIG. 6 is a schematic view of a sample of charging schedules utilized by the vehicle control device;

FIG. 7 is a schematic view of sample of heat maps that are generated by the electronic controller of the vehicle control device; and

FIG. 8 is an additional schematic view of sample of vehicle history information that is stored in the storage of the vehicle home setting device having corresponding state-of-charge data.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

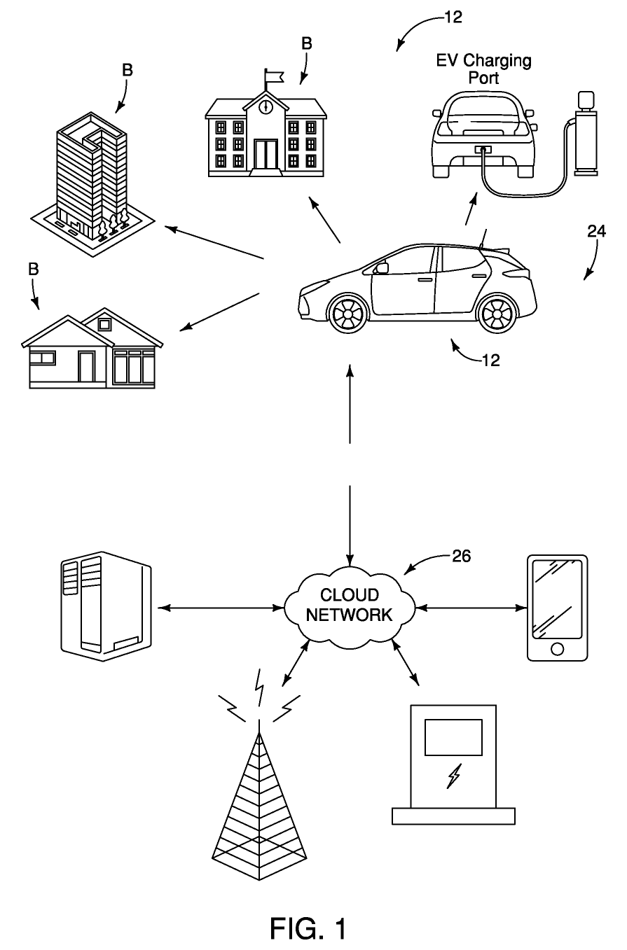

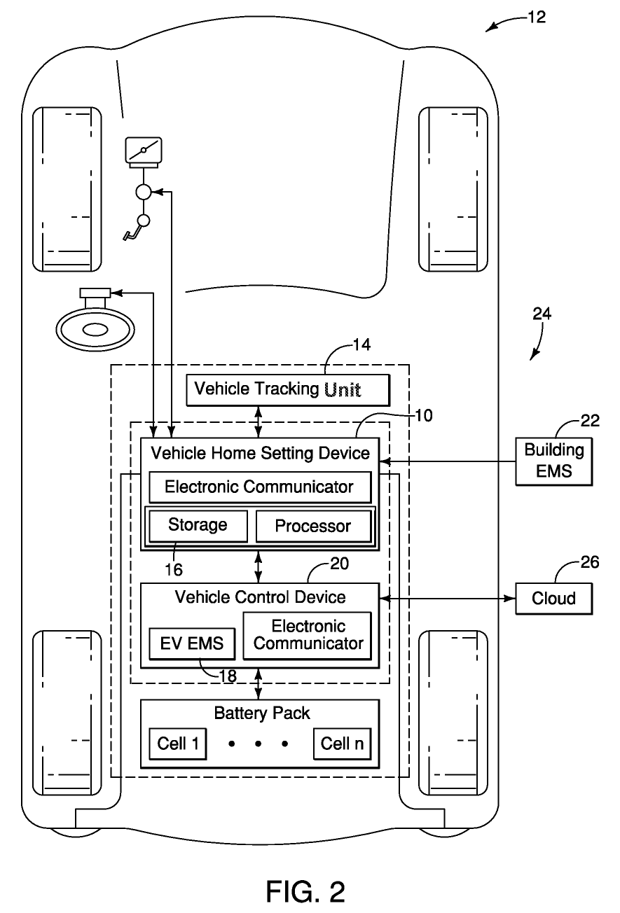

Referring initially to FIGS. 1 and 2, a vehicle control device for a vehicle 12 is illustrated in accordance with an embodiment. FIGS. 1 and 2 also illustrates a vehicle home setting device to be implemented with the vehicle control device. Together, the vehicle home setting device and the vehicle control device can be considered components of a vehicle control system C illustrated in FIGS. 1 and 2. Therefore, the vehicle control system C can a vehicle tracking system 14 for the vehicle 12, a non-transitory computer readable medium (hereinafter storage 16) and one or more electronic controller(s) 18 (shown as EV EMS 18 or EV energy management system). Also shown in FIG. 1, the vehicle control device 20 can be implemented with the vehicle home setting device 10 and the vehicle 12 and can include components of the vehicle home setting device 10. The vehicle control device 20 further comprises an electronic charging schedule generator 22 (shown as building EMS 22 or building energy management system) as will be further described below.

The vehicle control device 20 provides an improved device for generating one or more charging schedules for the vehicle 12 which can be an electric vehicle. The vehicle control device 20 provides a technological improvement in the technical field of generating the charging schedules which can be based on vehicle travel history and the home determination of the vehicle home setting device 10, as will be described below. In the illustrated embodiment, the term “charging schedule(s)” will refer to a charge level with respect to time graph or chart for determining a rate or degree of vehicle charging with respect to time.

In the illustrated embodiment, the term “home location” or “home locations” include one or more locations that are visited by the vehicle 12 that is designated by the vehicle home setting device 10 to be the location in which the vehicle 12 spends more time relative to other locations. The vehicle home setting device 10 designates or categorizes these “home locations” in the storage 16, which can be updated over time depending on vehicle behavior. That is, the home location can be updated over time as the vehicle 12 travels. The home location categorization can be used to better determine vehicle charging demand maps 32 or schedules for the vehicle 12 if the vehicle 12 is an electric vehicle, as will be further described below.

In the illustrated embodiment, the term “home location” can refer to a frequently visited location in which the vehicle will receive electronic charge. Therefore, the “home location” can include or refer to an office location where the owner parks during work hours, an actual home location where the owner parks during sleep time, or any other frequently visited location such as a close relative’s home, etc.

The EV EMS 18 of the vehicle control device 20 described herein can include one or more electronic controller(s) that can be provided on-board the vehicle 12. Alternatively, the EV EMS 18 can be provided to an external network, such as a cloud network 26 that is in electronic communication with the vehicle 12, as described herein. Therefore, the calculations, determinations and method executed by the EV EMS 18 described herein can occur either on-board the vehicle 12 or on the external network or cloud network 26.

Therefore, the EV EMS 18 of the illustrated embodiment preferably includes an electronic communicator such as a wireless communication device. The term “electronic communicator” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. The wireless communication signals can be radio frequency (RF) signals, ultra-wide band communication signals, or Bluetooth communications or any other type of signal suitable for wireless communications as understood in the bicycle field.

Here, an electronic communicator of the EV EMS 18 is in electronic communication with the storage 16 that stores personalized vehicle history of the vehicle 12 during vehicle travel. The electronic communication being in further communication with the building EMS that is external to the vehicle 12.

As seen in FIG. 2, the storage 16 stores the vehicle visit locations and the home location(s) that are categorized by the vehicle home setting device 10. The vehicle home setting device 10 can designate certain vehicle visit locations (e.g., the owner’s true home, the owner’s place of work or the owner’s close relative’s home, etc) as being “home locations” with stored information of vehicle visit times and durations. The EV EMS 18 can generate suggested charging schedule(s) based on this data that is stored by the home setting device 10.

As with the EV EMS 18, the storage 16 can be provided on-board the vehicle 12 or alternatively, to the external network, such as the cloud 26. Therefore, the storage 16 and the EV EMS 18 are provided on one or the other of the on-board network of the vehicle 12 and the external network that is external to the vehicle and the building structure B.

As shown FIG. 1, the charging schedule generator 22 is to be implemented with a vehicle charging structure, such as a building structure B having one or more charging ports for charging electric vehicles EV when the electric vehicles EV are plugged into the charging ports. The charging ports are connected to an electric source that powers the building structure B. The electric source can be a traditional electric source, such as an electric grid. Alternatively, the electric source can be forms of renewable energy such as solar panels that are installed to the building structure B.

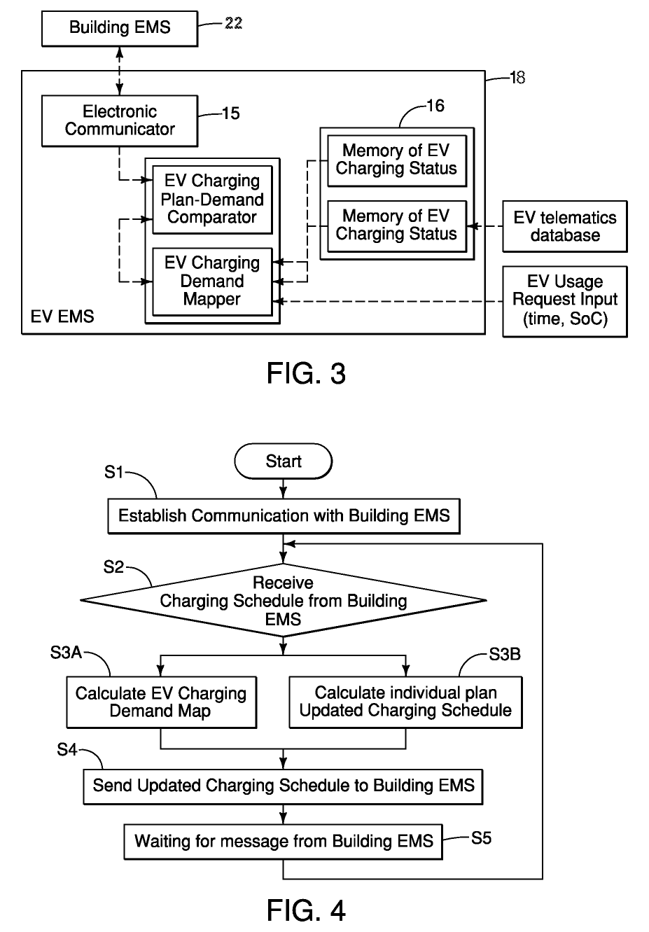

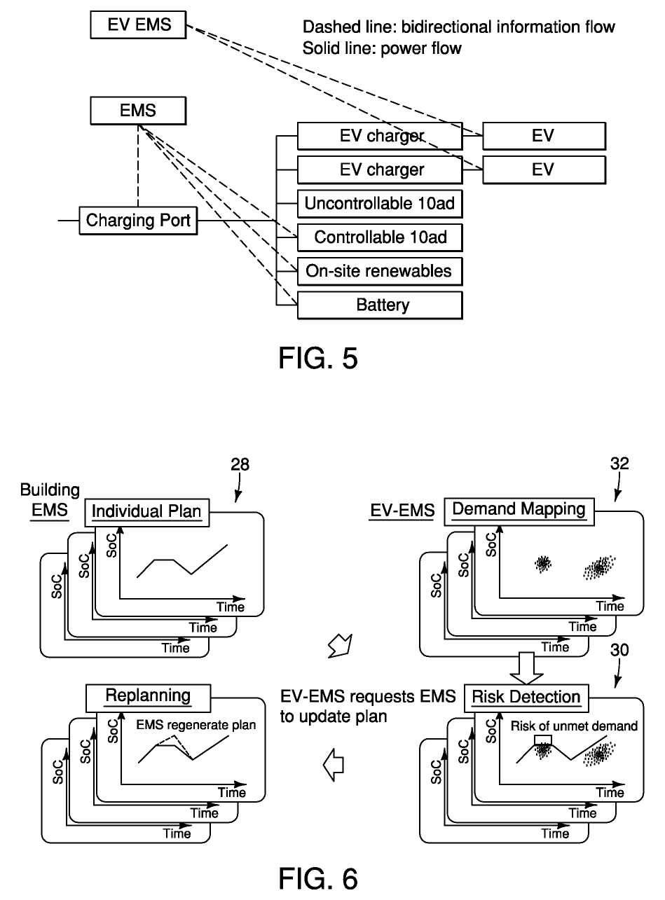

The charging port is provided at the building structure B that is powered by the electric source. The building structure B has one or more charging ports. As shown in FIGS. 1 and 3, the charging schedule generator 22 can be implemented with a plurality of building structures B that can include community use buildings (e.g., office buildings or apartment buildings) or stand-alone homes. Therefore, the charging control device can comprise a plurality of building structures B. The building structure B can be a home location for the vehicle 12 for the purposes of the vehicle home setting device 10.

Referring to FIG. 2, the vehicle tracking system 14 can include a global positioning device (GPS) and a telemetry control unit. Therefore, the telemetry control unit is an embedded computer system that wirelessly connects the vehicle to cloud 26 services or other the vehicle network via vehicle-to-everything (V2X standards) over a cellular network. The telemetry control unit collects telemetry data regarding the vehicle, such as position, speed, engine data, connectivity quality etc. by interfacing with various sub-systems and control busses in the vehicle 12. The telemetry control unit can include an electronic processing unit, a microcontroller, a microprocessor or field programmable gate array (FPGA), which processes information and serves to interface with the GPS unit.

The vehicle tracking system 14 can also provide in-vehicle connectivity via Wi-Fi and Bluetooth. The vehicle tracking system 14 can further include a mobile communication unit and memory for saving GPS values in case of mobile-free zones or to intelligently store information about the vehicle's sensor data.

As stated, the storage 16 can be provided on a cloud 26 or a cloud network 26 in electronic communication with the vehicle 12. In this case, the vehicle tracking system 14 can communicate with the storage 16 via an access point. The access point can be a base station, a base transceiver station (BTS), a Node-B, an enhanced Node-B (eNode-B), a Home Node-B (HNode-B), a wireless router, a wired router, a hub, a relay, a switch, or any similar wired or wireless device. The vehicle 12 can communicate with the vehicle network via the vehicle tracking system 14. In other words, the vehicle tracking system 14 can be in communication via any wireless communication network such as high bandwidth GPRS/1XRTT channel, a wide area network (WAN) or local area network (LAN), or any cloud-based communication, for example. Therefore, using the vehicle tracking system 14, the vehicle 12 can participate in a computing network or a cloud 26-based platform.

The electric communicator can also be a wireless communicator that includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. The wireless communication signals can be radio frequency (RF) signals, ultra-wide band communication signals, or Bluetooth communications or any other type of signal suitable for wireless communications as understood in the vehicle field. Here, the electric communicator 15 can be a one-way wireless communication unit such as a transmitter.

The EV EMS 18 is a computer that includes one or more processors to execute the functions of the vehicle home setting device 10. As used herein this disclosure, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

The processor can execute instructions transmitted by one or more transmission media, including coaxial cables, copper wire and fiber optics, including the wires that comprise a system bus coupled to a processor of a computer. As used herein, the terminology “instructions” may include directions or expressions for performing any method, or any portion or portions thereof, disclosed herein, and may be realized in hardware, software, or any combination thereof.

For example, instructions may be implemented as information, such as a computer program, stored in memory that may be executed by the processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

Computer-executable instructions can be compiled or interpreted from computer programs created using a variety of programming languages and/or technologies, including, without limitation, and either alone or in combination, Java™, C, C++, Visual Basic, Java Script, Perl, etc. In general, the processor receives instructions from the storage 16 and executes these instructions, thereby performing one or more processes, including one or more of the processes described herein. Such instructions and other data may be stored and transmitted using a variety of computer-readable media.

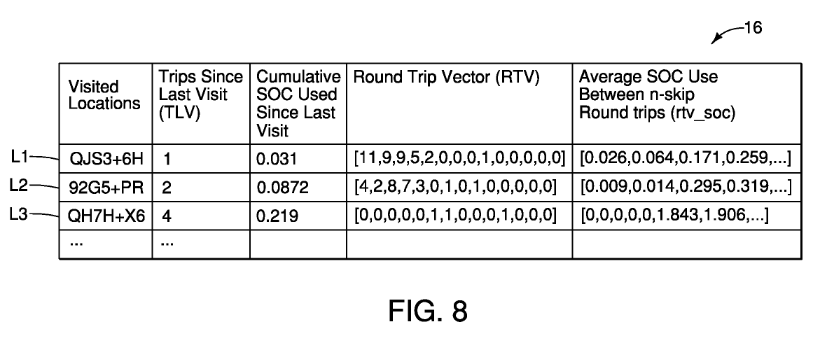

The storage 16 electronically stores the vehicle visit locations during vehicle travel as it receives telemetry information from the vehicle tracking system 14. The vehicle visit locations can be identified by a location code or a GPS latitude and longitudinal code. In FIG. 8, the sample visit locations that have been visited by the vehicle include locations QJ53+6H (alternatively Location 1 or L1), 92G5+PR (alternatively Location 2 or L2), QH7H+X6 (alternatively Location 3 or L3).

Referring to FIGS. 2 to 4, the building EMS 22 is part of a building management system that generates charging schedules 28 for electric vehicles obtaining electric charge at a building structure B. The building EMS 22 and the EV EMS 18 are in communication with one another such that the EV EMS 18 transmits suggested charging schedules 30 to the building EMS 22.

The storage 16 of the vehicle control device 20 can be provided on-board the vehicle 12 or on the vehicle cloud 26 that is external to the vehicle 12. The EV EMS 18 can also be provided on-board the vehicle 12 or on the vehicle cloud 26 that is external to the vehicle 12. Therefore, the storage 16 and the EV EMS 18 are provided on one or the other of an on-board network of the vehicle 12 and an external network that is external to the vehicle 12 and the building structure B.

It has been known that when a large numbers of electric vehicles EV are being charged at a building structure B, a lot of power is being drawn from the electric source at a particular time, especially if many electric vehicles EV arrive at around the same time period. In such a situation, a large number of electric vehicles EV concurrent with high electricity use in the building otherwise can overwhelm the electric source or the electric grid.

Therefore, the building EMS 22 can generate unique charging schedules for each electric vehicle EV based on vehicle need and building supply. In the instance of a building structure B that includes multiple charging ports, the building EMS 22 preferably generates charging schedules to prevent the electric vehicles EV from overwhelming the electric load of the building structure B. The building EMS 22 also preferably generates charging schedules to avoid peak electricity price hours. The building EMS 22 preferably generates charging schedules to avoid charging the electric vehicle 12 during peak electricity price hours. Therefore, the building EMS 22 is configured to determine when the vehicle 12 accesses a charging port provided at a building structure B that is powered by an electric source.

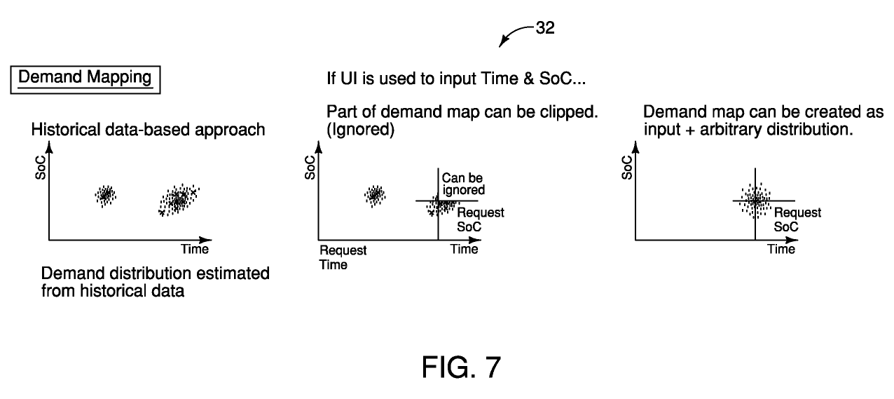

In the illustrated embodiment, the EV EMS 18 is configured to provide suggested charging schedules 30 to the building EMS 22, as best seen in FIGS. 6 and 7. The demand maps 32 are based on the personalized vehicle history as will be further described below. In particular, the suggested charging schedules 30 are based on vehicle travel history and telemetry data, as will be further described below. In the illustrated embodiment, the building EMS 22 transmits a charging schedule 28 to the electric communicator of the vehicle 12. The electric communicator transmits the charging schedule 28 to the cloud 26 where the EV EMS 18 compares the charging schedule 28 to the personalized vehicle history, such as travel data or location visit data.

Therefore, the personalized vehicle history includes vehicle travel history, such as the travel history accumulated by the vehicle tracking system 14 as described above. For example, as shown in FIG. 8, the storage 16 can store state-of-charge data relative to vehicle travel history and state-of-charge use between vehicle intermediary trips. Additionally, the personalized vehicle history can include user inputted preference. The personalized vehicle history can also include aggregate data of when the vehicle 12 is located at the building structure B. Based on the comparison, the EV EMS generates a suggested charging schedule to the building EMS which is transmitted back to the building EMS of the building structure B.

It has been known that conventional charging schedules are generated based on user input for state-of-charge or the times for a vehicle arriving or leaving the building structure B. However, conventional methods require sharing private data with the building which can result in too much data sharing or loss of the vehicle owner’s privacy. Additionally, conventional charging schedule generation requires perfect information sharing from drivers to the building structure B, which is subject to inaccuracies as it places a high burden on user sharing of information. In the illustrated embodiment, by enabling a comparison mechanism on the EV EMS 18, user data such as arrival and leave times do not have to be shared with the building.

The EV EMS 18 is configured to determine when an electric vehicle user P accesses the charging port. Therefore, the EV EMS 18 is equipped with the electric communicator. The electric communicator can be a wired connection that is established between the electric vehicle EV and the charging port when the electric vehicle EV is plugged into the charging port. Therefore, the electric communicator can include a power-line communication (PLC) that utilizes modulated carrier signals to transmit information between the electric vehicle 12 and the EV EMS 18.

In the illustrated embodiment, the EV EMS 18 for the vehicle control device 20 preferably generates suggested charging schedules 30 in conjunction with the vehicle home setting device 10. That is, the vehicle control device 20 can generate suggested charging schedules 30 based on a determination or categorization of vehicle home locations. For example, the vehicle control device 20 can use the home setting or information such that the suggested charging schedule 30 recommends increased charging for locations more likely to be the vehicle’s 12 true home. As the vehicle home setting device 10 categorizes home locations based on the location scores for the stored vehicle locations, the location scores can inform the vehicle control device 20. That is, the vehicle control device 20 can generate suggested charging schedules 30 having suggested charging sections corresponding to when the vehicle 12 is located at locations with higher location scores. For example, a user’s home or office locations will receive higher location scores. In this case, the EV EMS can generate suggested charging schedules 30 accordingly for these locations.

Referring to FIG. 3, the components of the EV EMS 18 are illustrated. As shown, the EV EMS 18 comprises the electric communicator and memory or storage 16. As stated, the storage 16 stores personalized travel information of the vehicle 12 such as vehicle travel information from the vehicle tracking system 14. The EV EMS 18 also contains processing functions or a processor capable of generating a charging demand map 32 based on the personalized vehicle information which can include historical EV charging status, EV charging history and travel history. The processor for the EV EMS 18 can compare the charging demand maps 32 with the charging schedules 28 generated by the building EMS 22. In this way, the EV EMS 18 can then generate suggested charging schedules 30 based on the comparison and transmit that to the building EMS 22.

Referring to FIG. 4, the processes of the vehicle control device 20 can be further described. When the vehicle 12 is plugged into a building charging port or when the user accesses an application software on a mobile device, the EV EMS 18 is in communication with the building EMS 22. In step S1, the EV EMS 18 establishes communication with the building EMS 22. In step S2, the EV EMS 18 receives a charging schedule for the vehicle 12 from the building EMS 18.

In step S3A, the EV EMS 18 calculates a charging demand map 32 for the vehicle 12. In particular, the charging demand map 32 generated by the EV EMS is preferably a heat map 34. Therefore, the EV EMS 18 is programmed to generate the heat map 34 based on vehicle travel history received from the vehicle tracking system 14. Referring to FIG. 7, the vehicle travel history used to generate the charging demand map 32 can include historical departure time from the building structure B and historical end state-of-charge at the departure time. The vehicle travel history can also include historical departure time and historical change in state-of-charge between an end charge time and a next charge start time. The vehicle travel history can also include historical departure time and historical change in state-of-charge between an end charge time and a state-of-charge during arrival at a charging spot.

It will be apparent to those skilled in the vehicle field from this disclosure that the EV EMS 18 can additionally take into account user input and just simply current state-of-charge of the vehicle 12. Thus, the EV EMS 18 is programmed to receive the charging schedule 28 and to compare the charging schedule with the personalized vehicle history that are illustrated as charging demand maps 32, as shown in FIG. 6. Therefore, the EV EMS 18 is programmed to compare the charging schedule 28 generated by the building EMS to vehicle visit locations stored in the storage 16.

The EV EMS 18 is further programmed to compare the heat map 34 to the charging schedule 28 that is generated by the building EMS 22 to generate the updated or suggested charging schedule 30 in step S3B. As stated, the EV EMS 22 is further programmed to generate the updated or suggested charging schedule 30 based on the comparison of the heat map 34 to the charging schedule 28. The EV EMS 18 then transmits the suggested charging schedule 30 to the building EMS 22 in step S4. The EV EMS 18 then waits to receive any updates or messages from the building EMS in step S5, such as information regarding revisions to the original charging schedule based on the suggested charging schedule 30 that is transmitted by the EV EMS 18.

Referring to FIG. 6, sample charging schedules generated by the building EMS and the EV EMS are shown. The building EMS 22 generates a charging schedule 28 as shown as a state-of-charge relative to time graph. Typically, the charging schedules 28 generated by the building EMS 22 for vehicles parked for prolonged periods will have at least one charge section, at least one discharge section and at least one recharge section.

As a further example shown in FIG. 7, the EV EMS 18 generates a charging demand map 32 that is illustrated as a heat map graphed as state-of-charge relative to time graph. The state-of-charge graph is a heat map based on the vehicle travel history. In other words, the EV EMS 18 is programmed to generate a state-of-charge graph with respect to time based on the personalized vehicle history.

As stated, the EV EMS 18 is programmed to compare the charging schedule 28 with the charging demand map 32 in order to generate a suggested charging schedule 30, as shown. That is, the EV EMS 18 is further programmed to compare the state-of-charge graph with the charging schedule 28 of the building EMS 22. The suggested charging schedule 30 is then transmitted to the building EMS 22 for replanning by the building EMS 22. As shown, the suggested charging schedule 30 includes at least one charge section and at least one discharge section. The suggested charging schedule 30 further includes at least one recharge section.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle control device. Accordingly, these terms, as utilized to describe the present invention should be interpreted relative to a vehicle equipped with the vehicle control device.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An electric vehicle control device comprising:
an electronic charging schedule generator configured to generate a charging schedule when a vehicle accesses a charging port provided at a building structure that is powered by an electric source;
a non-transitory computer readable medium electronically storing personalized vehicle history of the vehicle during vehicle travel; and
an electronic controller programmed to receive the charging schedule and to compare the charging schedule with the personalized vehicle history, the electronic controller being programmed to generate an updated charging schedule based on the comparison.

2. The electric vehicle control device according to claim 1, wherein
the electric controller is programmed to generate a state-of-charge graph with respect to time based on the personalized vehicle history, the electronic controller being further programmed to compare the state-of-charge graph with the charging schedule of the electronic charging schedule generator.

3. The electric vehicle control device according to claim 2, wherein
the electronic controller is programmed to transmit the updated charging schedule to the electronic charging schedule generator.

4. The electric vehicle control device according to claim 3, wherein
the non-transitory computer readable medium and the electronic controller are provided on one or the other of an on-board network of the vehicle and an external network that is external to the vehicle and the building structure.

5. The electric vehicle control device according to claim 4, wherein
the state-of-charge graph is a heat map of vehicle travel history.

6. The electric vehicle control device according to claim 1, wherein
the personalized vehicle history includes vehicle travel history.

7. The electric vehicle control device according to claim 1, wherein
the personalized vehicle history includes user inputted preference.

8. The electric vehicle control device according to claim 6, wherein
the electric controller is programmed to generate a state-of-charge graph with respect to time based on the personalized vehicle history, the electronic controller being further programmed to compare the state-of-charge graph with the charging schedule of the electronic charging schedule generator.

9. The electric vehicle control device according to claim 8, wherein
the electronic controller is programmed to transmit the updated charging schedule to the electronic charging schedule generator.

10. The electric vehicle control device according to claim 9, wherein
the non-transitory computer readable medium and the electronic controller are provided on one or the other of an on-board network of the vehicle and an external network that is external to the vehicle and the building structure.

11. The electric vehicle control device according to claim 1, wherein
the personalized vehicle history includes aggregate data of when the vehicle is located at the building structure.

12. The electric vehicle control device according to claim 11, wherein
the electric controller is programmed to generate a state-of-charge graph with respect to time based on the personalized vehicle history, the electronic controller being further programmed to compare the state-of-charge graph with the charging schedule of the electronic charging schedule generator.

13. The electric vehicle control device according to claim 12, wherein
the electronic controller is programmed to transmit the updated charging schedule to the electronic charging schedule generator.

14. The electric vehicle control device according to claim 13, wherein
the non-transitory computer readable medium and the electronic controller are provided on one or the other of an on-board network of the vehicle and an external network that is external to the vehicle and the building structure.

15. The electric vehicle control device according to claim 14, wherein
the state-of-charge graph is a heat map of vehicle travel history.

16. The electric vehicle control device according to claim 15, wherein
the updated charging schedule includes at least one charge section and at least one discharge section.

17. The electric vehicle control device according to claim 16, wherein
the updated charging schedule further includes at least one recharge section.

18. An electronic controller comprising:
an electronic communicator in electronic communication with a non-transitory computer readable medium electronically storing personalized vehicle history of the vehicle during vehicle travel, the electronic communication being in further communication with an electronic charging schedule generator external to a vehicle that is configured to generate a charging schedule when the vehicle accesses a charging port provided at a building structure that is powered by an electric source,
the electronic controller being programmed to receive the charging schedule and to compare the charging schedule with the personalized vehicle history, the electronic controller being programmed to generate an updated charging schedule based on the comparison.

19. The electronic controller according to claim 18, wherein
the electric controller is further programmed to generate a state-of-charge graph with respect to time based on the personalized vehicle history, the electronic controller being further programmed to compare the state-of-charge graph with the charging schedule of the electronic charging schedule generator.

20. The electronic controller according to claim 19, wherein
the electronic controller is further programmed to transmit the updated charging schedule to the electronic charging schedule generator.
